(19) United States
(12) Patent Application Publication
(10) Pub. No.: US 2009/0200964 A1
(43) Pub. Date: Aug. 13, 2009

(54) Methods And Apparatus For Dimmable Ballasts With A High Power Factor

(76) Inventor: Ray J. King, Carolina Beach, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/178,397

(22) Filed: Jul. 23, 2008

Related U.S. Application Data
(60) Provisional application No. 61/006,965, filed on Feb. 8, 2008.

(51) Int. Cl. H05B 41/36

(52) U.S. Cl. 315/307

(57) ABSTRACT

Methods and apparatus for powering dimmable ballast circuits are disclosed. In the described examples, a dimmable ballast circuit includes a rectifier, an energy storage device, a driver circuit, and a resonant circuit that are configured to actuate the light source such as a fluorescent lamp. Specifically, energy storage device is a capacitor that stores a high frequency energy and continually recycles energy in the circuit, resulting in a circuit with a large power factor. Further, because the current flowing into the resonant circuit is substantially sinusoidal, the circuit generally has an ideal crest factor, thereby increasing the lifespan of the light source.

### RELATED APPLICATIONS

This application claims the benefit under 35 U.S.C. §119(e) to U.S. Provisional Patent Application entitled “Dimmable Ballast with High Power Factor” filed on Feb. 8, 2008, bearing Ser. No. 61/006,965, which is herein incorporated by reference for all that it teaches.

### FIELD OF THE DISCLOSURE

The present disclosure relates generally to electronic lighting ballasts and, more particularly, to methods and apparatus for dimmable ballasts with high power factor.

### SUMMARY

Methods and apparatus for powering dimmable ballast circuits are disclosed. A described dimmable ballast circuit includes a power source coupled to a first node and a second node, the power source having a current that alternates at a line frequency. The first node and the second node are coupled to each other via an energy storage device that stores energy at a first frequency that exceeds the line frequency of the power source. A first switch is operable to selectively couple the energy storage device to a resonant circuit via the first node. The resonant circuit has a resonant frequency and stores energy during a first portion of a cycle of the first frequency. A second switch is operable to selectively couple the energy storage device to a resonant circuit via the second node to cause energy stored in the resonant circuit to be substantially stored in the energy storage device during a second portion of the cycle of the first frequency.

### BACKGROUND

In the field of light sources (e.g., gas discharge lamps, fluorescent lamps, light emitting diodes, etc.), the light sources generally present a negative resistance that cause the power source to increase the amount of current provided. To limit the current, a ballast circuit is typically provided that limits the amount of current provided to the light source. FIG. 1 illustrates a conventional ballast circuit with a high power factor and includes a high power factor correction circuit. However, such power factor correction circuits generally have a poor efficiency caused by losses due to a power transistor and a power diode. As a result, such ballast circuits typically have a poor efficiency and increases the number of components used in a conventional power factor correction ballast. Further, such ballast circuits generally include a low temperature electrolytic capacitor that substantially limits the life of the ballast.

### BRIEF DESCRIPTION OF THE DRAWINGS

FIG. 1 illustrates a conventional ballast having a high power factor correction circuit.

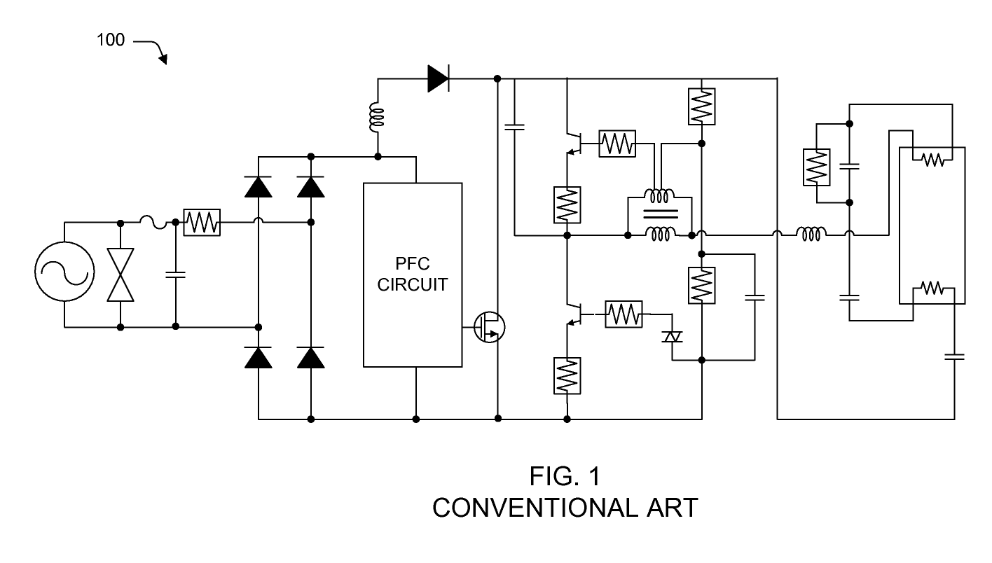

FIG. 2 illustrates a block diagram of an example ballast circuit having a high power factor in accordance with the present invention.

FIG. 3 is a flow diagram of a process that the example ballast circuit of FIG. 2 may implement.

FIG. 4 is a schematic diagram of an example circuit that may implement the example process of FIG. 3.

FIG. 5 illustrates is a voltage waveform diagram that illustrates the operation of an exemplary rectifier of the circuit of FIG. 4.

FIG. 6 is a voltage waveform diagram that illustrates the operation of an exemplary regulator of the circuit of FIG. 4.

FIGS. 7 and 8 are equivalent circuits that illustrate the operation of the example circuit of FIG. 4.

FIG. 9 is a voltage waveform diagram that illustrates the voltage at the resonant circuit of FIG. 4.

### DESCRIPTION

Methods and apparatus for dimmable ballasts with a high power factor are described herein. In the described examples, a dimmable ballast circuit having a high power factor is described that directly interfaces a power source with a light source via a single resonant circuit. In addition, the described dimmable ballasts include a high frequency filter capacitor to recycle high frequency energy during its operation to increase efficiency.

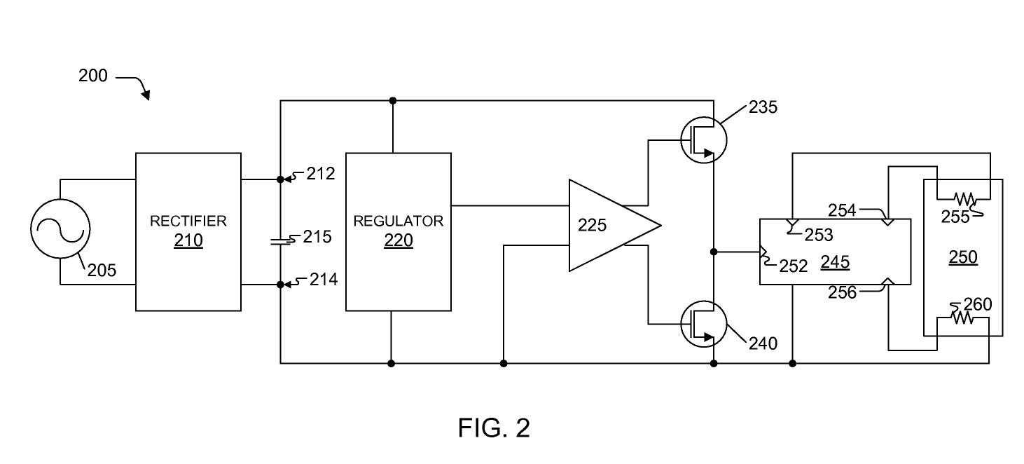

FIG. 2 illustrates a block diagram of an example ballast circuit 200 configured to have a high power factor, generally approaching a power factor of unity (e.g., 0.90-0.99, etc.). In particular, the example ballast circuit 200 includes a high power factor correction that is performed in a single stage of impedance transformation, thereby eliminating the need for a separate high power factor correction circuit while retaining substantially the same functionality. Generally, the power factor is generally defined as the active power over the apparent power, which directly relates to the amount of power consumed by a circuit and the amount of power measured by the utility company, for example.

In the example of FIG. 2, the ballast 200 includes a power source 205 that is coupled to a rectifier 210. The power source 205 is typically an alternating current source that provides current having a magnitude that alternates at a line frequency (e.g., 60 hertz (Hz)). Rectifier 210 is typically a full wave rectifier that substantially inverts the negative magnitude of the current provided via the power source, thereby doubling the frequency of the line current (e.g., to 120 Hz). Rectifier 210 conveys the rectified current onto a first node 212 and receives current from a second node 214.

The first node 212 and the second node 214 are coupled via a high frequency energy storage device, such as a capacitor 215. In the example of FIG. 2, the capacitance value of the capacitor 215 is selected to have a value such that it presents a large impedance to the rectified current (i.e., the line frequency), thereby not substantially affecting the rectified current provided via rectifier 210. More particularly, the capacitance value of capacitor 215 in the example of FIG. 2 is selected to store high frequency energy, generally in the kilohertz (KHz) range. As such, capacitor 215 in the example of FIG. 2 has value of approximately 0.1 to 3 microfarads (μf) and is made of any suitable material (e.g., polypropylene, etc.) for a ballast having a power output of approximately 25 watts. In other examples, capacitor 215 may have a value of approximately 1 to 30 μf for a ballast having a power output of approximately 250 watts. That is, capacitor 215 generally has a capacitance value in the range of 4 to 120 nanofarads (nf) per watt of power. In the illustrated example, the capacitor 215 is a polypropylene capacitor that has a lifespan much greater than larger electrolytic capacitors that are used in conventional ballasts.

Ballast circuit 200 also includes a regulator 220 coupled to nodes 212 and 214. Regulator 220 generates a substantially constant voltage that exceeds a first threshold (e.g., 10 volts, etc.) to provide power to a driver 225. In the illustrated example, the driver 225 is configured to alternately actuate one of a first transistor 235 and a second transistor 240 at a carrier frequency. The example transistors 235 and 240 are both implemented using vertical N-Channel metal oxide semiconductor (NMOS) field effect transistors. Of course, one of ordinary skill in the art would know that the transistors 235 and 240 can be implemented by any suitable device (e.g., a P-channel metal oxide field effect transistor, an insulated gate bipolar transistor (IGBT), a lateral N-channel depletion mode MOS transistor, a bipolar transistors, a thyrsistor, etc.).

Driver 225 and transistors 235 and 240 form a half-bridge topology that is implemented to cause a resonant circuit 245 to power a light source 250 in the illustrated example. To form the half-bridge topology, the drain of the first transistor 235 is coupled to the first node 212 and the source of the second transistor 240 is coupled to the second node 214. The gates of the transistors 235 and 240 are both coupled to first and second outputs of the driver 225, respectively. Further, the source of the transistor 235 is coupled to the drain of the transistor 240, both of which are also coupled to the resonant circuit 245. The resonant circuit 245 has a resonant frequency (e.g., 20 KHz, etc.) and is also coupled to the second node 214 and a light source 250 (e.g., a gas discharge lamp, a fluorescent lamp, a light emitting diode (LED), etc.).

In particular, a first input 252 is coupled to the source and drain of NMOS transistors 235 and 240. A first output 253 of the resonant circuit 245 is coupled to a second input 254 of the resonant circuit 245 via a first filament 255 of the light source 250. Further, in the example of FIG. 2, a second output 256 of the resonant circuit 245 is coupled to the second node 214 via a second filament 260 of the light source 250. As will be described in detail below, the resonant circuit 245 stores energy and selectively charges and discharges energy into the light source 250 at a frequency that exceeds the line frequency of the rectified current, thereby exciting the light source 250 to visually emit light. Further, the resonant circuit 245 presents an impedance to the power source 205 to thereby limit the current flowing into the light source 250.

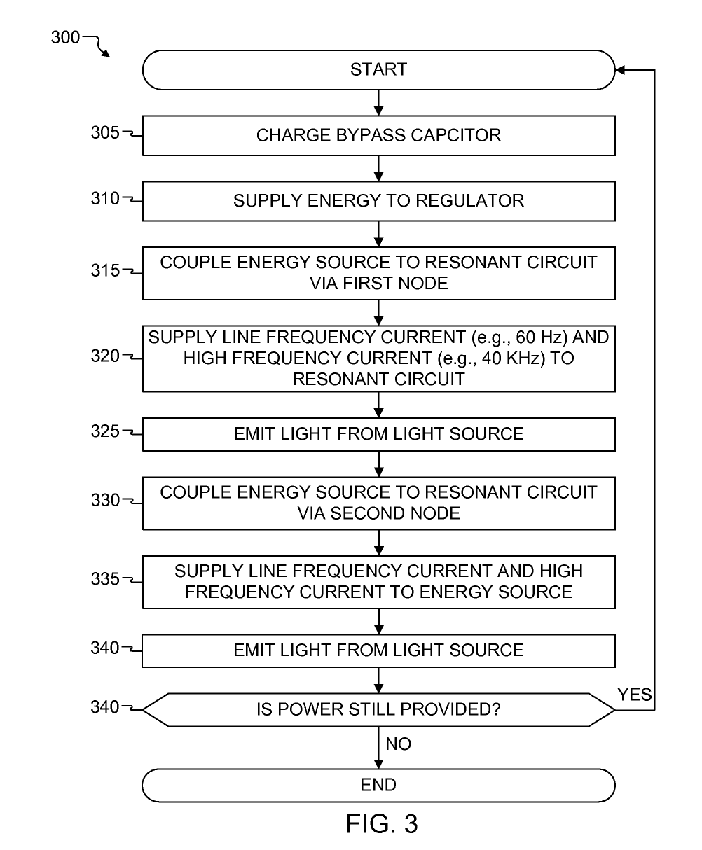

FIG. 3 illustrates an exemplary process 300 that ballast circuit 200 may implement when coupled to a power source (e.g., a alternating current source, etc.). If power is provided to the ballast, exemplary process 300 begins by charging a high frequency bypass capacitor. Specifically, the bypass capacitor presents a large impedance to a line frequency current of the power source having a low current (e.g., 60 Hz, 120 Hz, etc.) (block 310). In addition, exemplary process 300 supplies energy to charge a regulator that provides power to actuate a driver circuit, for example (block 310). In the example of FIG. 3, exemplary process 300 couples the energy source (e.g., a power supply, etc.) to a resonant circuit via a first node (block 315). In response, the energy source supplies the line frequency current and a high frequency current (e.g., 40 KHz) to the resonant circuit (block 320). In particular, the bypass capacitor provides the high frequency current via the first node. When the resonant circuit receives the line frequency current and the high frequency current, the resonant circuit has a voltage with a positive magnitude, thereby causing a light source coupled to the resonant circuit to emit light therefrom (block 325).

After emitting light from the light source, exemplary process 300 then couples the resonant circuit to the energy source via a second node (block 330), which supplies the line frequency current and the high frequency current to the energy source (block 335). As a result, the resonant circuit has a voltage with a negative magnitude, thereby causing the light source coupled to emit light therefrom (block 340). Exemplary process 300 determines if power is still provided by the energy source (block 345). If power is provided, Exemplary process returns to block 305. On the other hand, if power is not provided to the ballast, exemplary process ends.

In example of FIG. 3, the high frequency current in exemplary process 300 is stored in the bypass capacitor, thereby continually recycling the high frequency energy during its operation. In some examples, the high frequency current has a frequency generally in the range of approximately 20 to 40 KHz. Thus, according to exemplary process 300, the high frequency current continually recycles via the bypass capacitor, thereby preventing substantial energy loss. Further, the energy source is directly coupled to the resonant circuit via a low impedance path to prevent substantial loss of energy. Accordingly, the resulting circuit implementing such a process generally has a power factor of unity, a high efficiency, and an ideal crest factor.

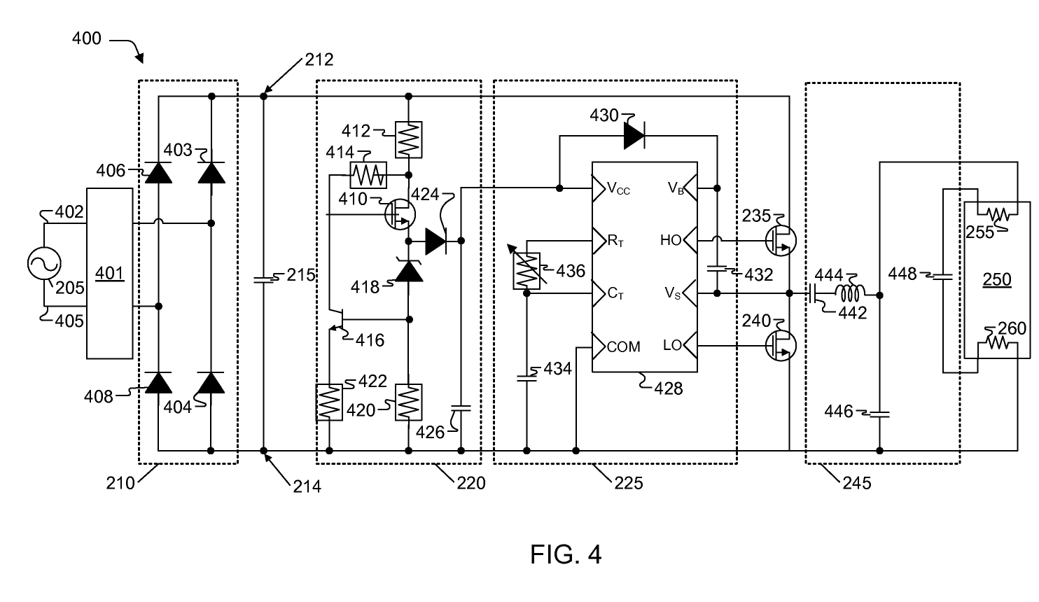

FIG. 4 is a schematic diagram of an exemplary circuit 400 that may implement exemplary process 300 (FIG. 3). In FIG. 4, power source 205 is coupled to rectifier 210 via a line filter 401, which insulates power source 205 from noise due (e.g., electromagnetic interference, etc.) generated by the balance of example circuit 400. More particularly, a first terminal 402 of the power source 205 is coupled to the anode of a diode 403 and the cathode of a diode 404 via the line filter 405. The cathode of the diode 403 is coupled to the first node 212 and the anode of the diode 404 is coupled to the second node 214. Further, a second terminal 405 of the power source 205 is coupled to the anode of a diode 406 and the cathode of a diode 408 via the line filter 405. The cathode of the diode 406 is coupled to the first node 212 and the anode of the diode 408 is coupled to the second node 214. The first node 212 and the second node 214 are coupled via the capacitor 215, which operates as a low impedance to high frequency energy.

Voltage regulator 220 is also coupled to first and second nodes 212 and 214 and is configured to provide a substantially constant voltage. In the illustrated example, voltage regulator 220 is implemented using an NMOS transistor 410 that is coupled to the first node 212 via a resistor 412. The drain of NMOS transistor 410 is coupled to its respective gate via a resistor 414. The gate of NMOS transistor 410 is further coupled to a collector of a transistor 416, which has its respective base coupled to the anode of a zener diode 418. The cathode of zener diode 418 is coupled to the source of NMOS transistor 410. In addition, the base of transistor 416 is coupled to second node 214 via resistor 420 and its emitter is coupled to the second node 214 via a resistor 422. In the example of FIG. 4, the source of the NMOS transistor 410 is coupled to the cathode of a diode 424 and the anode of diode 424 is coupled to the second node 214 via an energy storage device, such as a capacitor 426. As will be described below, capacitor 426 stores energy therein to provide a substantially constant voltage to the driver 225.

In the illustrated example of FIG. 4, driver 225 is implemented using any suitable circuit that selectively actuates transistors 235 and 240. Driver 225 in the exemplary circuit of FIG. 4 includes, for example, an International Rectifier™ 2153, which is a self-oscillating half-bridge driver circuit 428. However, one of ordinary skill in the art would understand that any suitable driver circuit could be implemented to perform the functions that the driver 225 provides (e.g., a 555 timer, etc.). In other examples, transistors 235 and 240 may be integral with the driver circuit 428 (e.g., a integrated circuit such as the STMicroelectronics™ L6574, etc.).

Referring to the driver 225, regulator 220 provides the substantially constant (i.e., regulated) voltage via diode 424, which also isolates voltage regulator 220 from driver 225. Stated differently, diode 424 prevents current from flowing from capacitor 426 into regulator 220 when the voltage of the first node 212 falls below the voltage stored in capacitor 426. In the example of FIG. 4, capacitor 426 and the cathode of diode 424 are also coupled to the supply voltage (V_{CC}) of driver circuit 428 to provide a substantially constant voltage to driver circuit 428. The capacitor 426 and the cathode of the diode 424 are also coupled to the anode of a diode 430, which is coupled to the high side floating supply voltage (V_{B}) of the driver circuit 428 via its respective cathode. Further, the cathode of the diode 430 is coupled the high side floating supply offset voltage (V_{S}) of the driver circuit 428 via a capacitor 432 and the second node 214 is coupled to the IC power and signal ground (COM) of the driver circuit 428.

In the illustrated example of FIG. 4, the frequency of driver circuit 428 is selected by presenting different impedances to the driver circuit 428. More particularly, the oscillating timing capacitor input (C_{T}) on pin 3 of the driver circuit 428 is coupled to the second node 214 via a capacitor 434. Further, the oscillator timing resistor input (R_{T}) of the driver circuit 428 is coupled to the oscillating timing capacitor input (C_{T}) of the driver circuit 428 via an adjustable resistor 436 (e.g., a potentiometer, a transistor presenting a variable resistance, etc.). In such a configuration, the carrier frequency of driver circuit 428 is variably controlled by adjusting the resistance of resistor 436, which is typically set during manufacturing, for example.

In the illustrated example, the resistance value of the resistor 436 and the capacitance value of the capacitor 434 configure the driver circuit 428 to produce pulses at a frequency in the range of approximately 20 to 100 KHz. Specifically, the pulses are alternately produced by driver circuit 428 and are output via the high side gate driver output (HO) and the low side gate driver output (LO). Stated differently, during the first half cycle of a period of the carrier frequency (i.e., the half of the time period for a single cycle), the high side gate driver output of the driver circuit 428 produces a pulse. During the second half cycle of the period (i.e., the low side of the cycle) of the carrier frequency, the low side gate driver output of the driver circuit 428 produces a pulse.

In the example of FIG. 4, the high side gate driver output (HO) is further coupled to the gate of NMOS transistor 235 and the low side gate driver output (LO) on pin 5 is coupled to the gate of NMOS transistor 240. In other examples, driver circuit 428 may be coupled to the gates of transistors 235 and 240 via resistors to prevent oscillations, for example. NMOS transistors 235 and 240 are also coupled to the high voltage floating supply return (V_{S}) of the driver circuit 428 via their source and drain, respectively. The drain of NMOS transistor 235 is coupled to the first node 212 and the source of NMOS transistor 240 is coupled to the second node 214.

As described above, the source of the NMOS transistor 235 and the drain of the NMOS transistor 240 are coupled to the resonant circuit 245, which selectively stores a charge therein. In the illustrated example, the resonant circuit 245 includes a capacitor 442 in series with an inductor 444. The inductor 444 is generally a gapped core inductor that is capable of handling a large peak current. The inductor 444 is coupled to the second node 214 via a capacitor 446 to store charge therein and excite the light source. Further still, the inductor 444 is coupled to a capacitor 448 via the first filament 255. The capacitor 448 is also coupled to the second node 214 via the second filament 260. The capacitor 448 receives current and stores a charge therein to excite the light source via current flowing across the filaments 255 and 260. The resonant frequency of the example resonant circuit 245 is described by equation 1 below:

$${f}_{R} = \frac{1}{2 π \sqrt{\begin{matrix}{L}_{444} {C}_{442} ( {C}_{446} + {C}_{448} ) \\ {C}_{442} + {C}_{446} + {C}_{448}\end{matrix}}} \qquad [ Equation 1 ]$$

where f_{R} is the resonant frequency of the circuit, L₄₄₄ is the inductance value of the inductor 444, C₄₄₂ is the capacitance value of the capacitor 442, C₄₄₆ is the capacitance value of the capacitor 446, and C₄₄₈ is the capacitance value of the capacitor 448. In the illustrated example, the capacitor 446 is configured to have a different value such that is has a different energy potential than the capacitor 448. In particular, the capacitor 446 has a larger voltage to allow the lamp 250 (FIG. 2) to turn on.

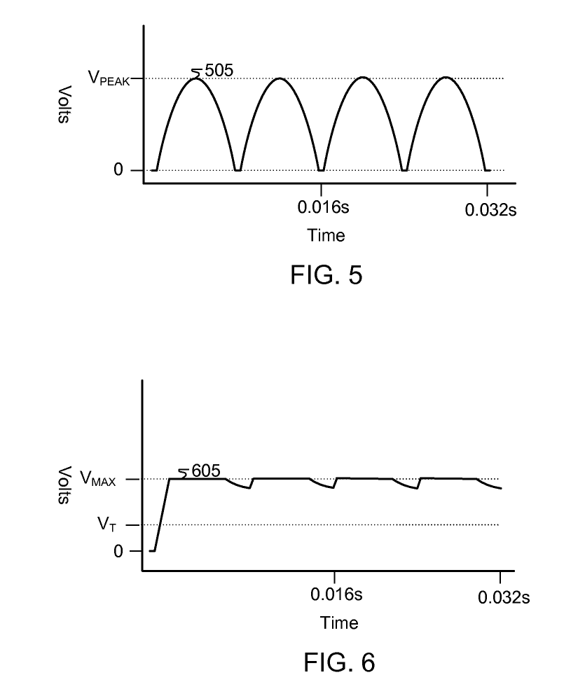

The operation of the example of FIG. 4 will be explained in conjunction with FIGS. 5-9, which illustrate the operation of the circuit 400. As described above, the rectifier circuit 210 rectifies the current provided via the power source 205, thereby doubling the line frequency. The exemplary waveform of FIG. 5 illustrates the voltage differential between the first node 212 and the second node 214, which is denoted by the reference numeral 505. As described above, the capacitor 215 presents a large impedance to the line frequency of the power source 205 and does not substantially affect the rectified alternating current at the nodes 212 and 214. In addition, the line filter 401 is configured to prevent high frequency energy from the capacitor 215 from entering the power source 205.

With respect to the operation of the voltage regulator 220, the resistor 414 causes the NMOS transistor 410 to have a gate-source voltage and, in response, it turns on to conduct current. In the illustrated example, the resistor 412 generally configures the transistor 410 in the safe operating area and experiences a failure in the event excessive current flows across it, thereby uncoupling the transistor 410 from the node 212. Initially, the zener diode 418 blocks current from the NMOS transistor 410 from flowing into the second node 214 by presenting a large impedance, which causes the current to flow toward the gate drive supply voltage (V_{CC}) on pin 1 of the driver circuit 428. When current flows toward the gate drive supply voltage, the capacitor 426 stores the current as a voltage to provide a substantially constant voltage to the driver circuit 428. As a result, the driver circuit 428 turns on and produces pulses via its respective outputs at a frequency determined by the resistance value of the adjustable resistor 436 and the capacitance value of the capacitor 434.

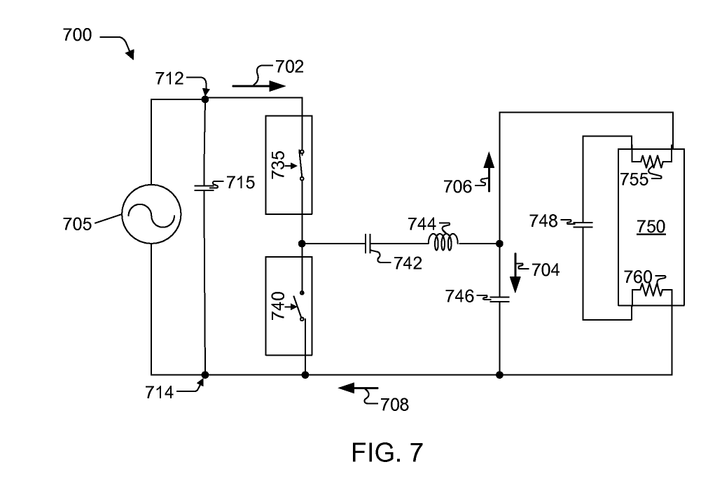

However, when the voltage across the zener diode 418 exceeds a corresponding breakdown voltage (e.g., −15.0 volts, etc.), the zener diode 418 enters what is commonly referred to as “avalanche breakdown mode” and allows current to flow from its cathode to its anode. In response, the current flows across the resistor 420 and causes the transistor 416 to have a base-emitter voltage (V_{BE}), thereby turning on the transistor 416. The transistor 416 sinks current into the second node 214, which reduces the gate-source voltage of the NMOS transistor 410 and the voltage across the zener diode 418. Once the voltage across the zener diode 418 does not exceed the breakdown voltage, the zener diode 418 recovers from the avalanche breakdown mode and stops current from flowing into the resistor 420. That is, as illustrated in the example of FIG. 6, by reducing the voltage at the source of the NMOS transistor 410 denoted by reference numeral 605, the voltage supplied to the driver circuit 428 does not substantially exceed the predetermined threshold voltage (V_{MAX}). In the example of FIG. 4, the resistance value of the resistor 422 is selected to reduce the loop gain of the transistor 416 to prevent oscillations and the resistance value of the resistor 420 is selected to prevent a leakage current from flowing via the zener diode 418.

Thus, the example voltage regulator 220 is configured to provide a substantially constant voltage to the driver 225. When the rectified voltage provided via the rectifier 210 falls below a predetermined threshold voltage (V_{T}), the voltage output by the voltage regulator 220 decreases. However, as illustrated in the example of FIG. 6, the energy storage device 426 has a corresponding voltage that exceeds a minimum threshold voltage (V_{T}) and continues to provide energy to the driver circuit 428. In addition, when the voltage at the node 212 falls below the voltage of the regulator 120, the diode 424 prevents current from flowing backwards from the capacitor 426 into the NMOS transistor 410.

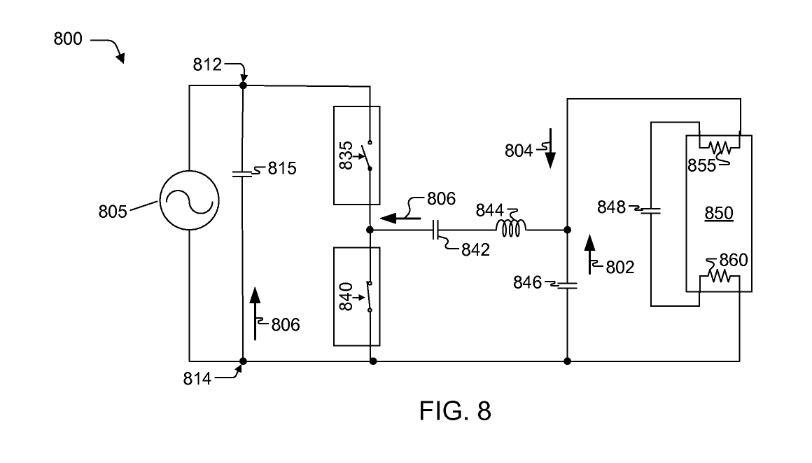

The driver circuit 428 is configured to generate a signal that alternately actuates one of the transistors 235 and 240 at a carrier frequency. In particular, during the first half of a single cycle of the carrier frequency, the high side output (HO) of the driver circuit 428 produces a high side pulse to turn on the transistor 235 and the transistor 240 is turned off. Typically, the high side pulse has a duration that does not exceed half of the time period of a cycle of the carrier frequency. When the driver circuit 428 turns on the transistor 235, the transistor 235 couples the node 212 to the resonant circuit 245 via a low impedance path. The example of FIG. 7 illustrates an equivalent circuit of a ballast circuit 700 and the flow of current when the transistor 735 couples the node 712 to the resonant circuit 245.

Initially, a current denoted by reference numeral 702 flows from the power source 705 and the capacitor 715 and into the resonant circuit 245 because the transistor 740 is turned off. The current 702 includes both line frequency current and high frequency current. In the example of FIG. 7, the capacitor 742 presents a high impedance to a low frequency, thereby limiting the line frequency current flowing into the inductor 744. As the current leaves the inductor 744, a current denoted by reference numeral 704 having the high frequency current flows into the capacitor 746, which stores a portion of the current as a voltage. In addition a current having the line frequency current and the high frequency current denoted by reference numeral 706 flows into the filament 755 and stores a portion of current in the capacitor 748 as a voltage. As a result of the line current and the high frequency current in the light source 750, the light source 750 emits a light that is generally visually perceptible. In addition, the line frequency current and a portion of the high frequency current, which are denoted by reference numeral 708 in the illustrated example, leave the resonant circuit 245 and returns to the power source 705. At the end of the first half cycle, the capacitor 715 stores substantially no energy therein.

During the second half of the time period of the carrier frequency, the low side output (LO) of the driver circuit 428 produces a low side pulse to turn on the transistor 240, and the transistor 235 is turned off. When the driver circuit 428 turns on the transistor 240, the transistor 240 couples the node 214 to the resonant circuit 245 via a low impedance path. The second pulse generally has a duration that does not exceed half the time period of the cycle of the carrier frequency. The example of FIG. 8 illustrates an equivalent circuit of the ballast circuit 800 (FIG. 4) and the flow of current when the transistor 840 couples the node 814 to the resonant circuit 245.

As described above, by turning on the transistor 840, the resonant circuit 245 is coupled to the second node 814 via a low impedance path. In response, the capacitors 846 and 846 discharge the voltage therein as currents denoted by reference numerals 802 and 804, respectively. The currents 802 and 804 flow into the inductor 844 and charge the capacitor 842 as a voltage, thereby causing the resonant circuit 245 to have a negative voltage with respect to the second node 814. As a result of current leaving the capacitors 846 and 848, the light source 850 is actuated to visually emit light. After a delay, the capacitor 842 releases the current as denoted by reference numeral 806, which flows into the node 814. However, because the capacitor 815 stores substantially no energy, the current 806 flows into the capacitor 815 from the node 814, which is stored as a voltage therein. At the end of the second half cycle of the carrier frequency, the resonant circuit 245 stores substantially no energy.

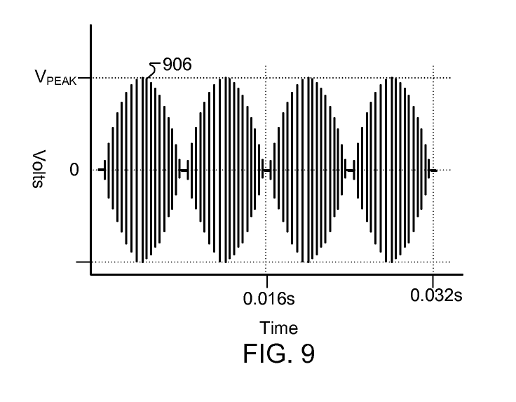

The illustrated example of FIG. 9 illustrates the voltage at the input of the resonant circuit 245 (i.e., the source of the NMOS transistor 235, etc.), which is denoted by reference numeral 905. Specifically, the operation of the exemplary circuit 400 (FIG. 4) causes the voltage at the input of the resonant circuit 245 to alternate between a positive magnitude and a negative magnitude at the carrier frequency. In particular, the ionization of the light source 250 causes the charge of the capacitor 442 to be substantially similar to a sine wave. Further, the magnitude of the voltage 905 is based on the magnitude of the current provided via the power source 205 (e.g., 60 Hz, etc.). Thus, circuit 400 turns the light source 250 (FIG. 2, etc.) on and off twice during each cycle of the carrier frequency and varies the magnitude of the power through the light source 250 at a rate of 120 Hz in the illustrated example, which is not generally perceptible to the human eye.

Thus, in the example of FIG. 9, the magnitude of the voltage at the input of the resonant circuit 245 is substantially similar to the input power provided via the power source 205. In particular, because the current flowing through the resonant circuit is substantially similar to a sine wave, the crest factor of the illustrated example is approximately the square root of 2 (e.g., 1.5, etc.), which is the ideal crest factor and substantially increases the lifespan of the light source 250. In addition, the example ballast circuit does not require a large electrolytic capacitor used in conventional ballasts to store substantial amounts of low frequency energy because the high frequency current is continually recycled by a non-electrolytic capacitor. Further, the impedance presented to the power source 205 is modified only by the resonant circuit and the example circuit 400 contains only a single inductor. As a result, the examples described herein realize a high power factor correction circuit with a single stage of processing with respect to the power source. In addition, because described examples do not require a large high voltage, low temperature electrolytic capacitor, the lifespan of such ballasts is substantially increased.

Although certain methods, apparatus, systems, and articles of manufacture have been described herein, the scope of coverage of this patent is not limited thereto. To the contrary, this patent covers all methods, apparatus, systems, and articles of manufacture fairly falling within the scope of the appended claims either literally or under the doctrine of equivalents.

What is claimed is:

1. A ballast circuit, comprising:
a power source coupled to a first node and a second node, the power source having a current that alternates at a line frequency, wherein the first node is coupled to the second node via an energy storage device that stores energy at a first frequency that exceeds the line frequency;
a first switch operable to selectively couple the energy storage device to a resonant circuit via the first node, the resonant circuit having a resonant frequency and being coupled to a light source, wherein the resonant circuit stores energy during a first portion of a cycle of the first frequency;
a second switch operable to selectively couple the energy storage device to a resonant circuit via the second node, the second switch causing energy stored in the resonant circuit to be substantially stored in the energy storage device during a second portion of the cycle of the first frequency.

2. A ballast circuit as defined in claim 1, further comprising a driver circuit to alternately actuate one of the first and second switches at the first frequency.

3. A ballast circuit as defined in claim 1, wherein the resonant circuit comprises:
a first capacitor having a first terminal coupled to the first and second switches;
an inductor having a first terminal coupled to a second terminal of the first capacitor;
a second capacitor having a first terminal coupled to the second terminal of the inductor, the second terminal of the capacitor being coupled to the second node; and
a third capacitor having a first terminal being coupled to the second terminal of the inductor via a light source, a second terminal of the third capacitor being coupled to the second node via the light source.

4. A ballast circuit as defined in claim 3, wherein the first capacitor is operable to limit the current provided to the light source.

5. A ballast circuit as defined in claim 4, wherein the first, second, and third capacitors are operable to store a portion of a current provided via the power source during the first portion of the cycle of the first frequency.

6. A ballast circuit as defined in claim 5, wherein the first, second, and third capacitors are operable to discharge the stored current during the second portion of the first frequency.

7. A ballast circuit as defined in claim 6, wherein the first portion of the first frequency is approximately a half cycle of the first frequency and the second portion of the first frequency is approximately a different half cycle of the first frequency.

8. A ballast circuit as defined in claim 1, wherein a first terminal of the power source is directly coupled to the light source via the resonant network during the first portion of the first frequency and a second terminal is directly coupled to the light source via the resonant network during the second portion of the first frequency.

9. A ballast circuit as defined in claim 1, wherein the energy storage device comprises a capacitor having a capacitance value of approximately in the range of 4 to 120 nanofarads per watt of power.

10. A ballast circuit as defined in claim 9, wherein the second capacitor is a polypropylene material.

11. A ballast circuit as defined in claim 1, wherein the first frequency exceeds the resonant frequency.

12. A ballast circuit as defined in claim 1, wherein the light source is selected from one of a fluorescent lamp and a gas discharge lamp.

13. A ballast circuit as defined in claim 1, wherein the resonant network matches the impedance of the power source.

14. A method of powering a ballast circuit, comprising:
storing a high frequency current in an energy storage device as a first voltage, the energy storage device being coupled to a first node and a second node;
selectively coupling the energy storage device to a resonant circuit via the first node for a first time period, wherein coupling the energy storage device to the first node generates a voltage in the resonant circuit to actuate a light source; and
selectively coupling the energy storage device to the resonant circuit via the second node for a second time period, wherein coupling the energy device to the second node generates a voltage in the resonant circuit to actuate a light source and store energy in the energy storage device.

15. A method as defined in claim 14, wherein selectively coupling the energy storage device to a resonant circuit via the first node comprises coupling the resonant circuit to a first terminal of a power source having a line frequency.

16. A method as defined in claim 15, wherein selectively coupling the energy storage device to a resonant circuit via the second node comprises coupling the resonant circuit to a second terminal of the power source.

17. A method as defined in claim 16, wherein the first time period is approximately equal to the corresponding time of a first half cycle of a first frequency and the second time period is approximately equal to the corresponding time of a second half cycle of a first frequency that exceeds the line frequency.
